(19) United States
(12) Patent Application Publication
(10) Pub. No.: US 2026/0024443 A1
(43) Pub. Date: Jan. 22, 2026

(54) Optimal Anthropomorphic Computing Runway Monitoring System

(71) Applicant: BiaTech Corporation, Tampa, FL (US)

(72) Inventor: Nathaniel HARTWIG, Tampa, FL (US)

(21) Appl. No.: 19/054,393

(22) Filed: Feb. 14, 2025

Related U.S. Application Data
(60) Provisional application No. 63/673,498, filed on Jul. 19, 2024.

(51) Int. Cl. G08G 5/70; G06V 20/54; G08G 5/23

(52) U.S. Cl. CPC G08G 5/70; G08G 5/23; G06V 20/54

(57) ABSTRACT

The disclosure principles provide a system and method for monitoring aircraft and runways. The system includes a plurality of sensors to collect aircraft and runway data. The sensors are disposed about a runway and include fiber optic sensors, cameras, microphones, gas sensors, and thermal sensors. The system also includes a computing device with an artificial intelligence-enabled program configured to analyze collected data and generate a multimodal output. The computing device is supported by a central cloud platform for multi-system learning. The multimodal output includes visual, auditory, tactile, olfactory, and gustatory stimuli. The system also includes a user interface configured to present the multimodal output to at least one user and collect user input data for storage, analysis, and future artificial intelligence improvement.

### CROSS-REFERENCE TO RELATED APPLICATIONS

The present application is related to U.S. Provisional Patent Application 63/673,498 filed Jul. 19, 2024, entitled “System for Analysis of Real-Time Data at the Sensor Edge of an Industrial Facility”. The present application hereby claims priority under 35 U.S.C. § 119 (e) to U.S. Provisional Patent Application No. 63/673,498. The above-identified provisional patent application is hereby incorporated by reference in its entirety.

### TECHNICAL FIELD

The present disclosure relates in general to the field of runway monitoring, and more particularly to a novel runway system and method for precise aircraft and runway data collection, analysis, and presentation.

### BACKGROUND

To ensure safe, efficient operations, airports continuously monitor runway conditions to detect potential hazards like debris, ice, or runway damage. This technology has been in use for several decades, evolving from basic visual inspections to more advanced systems that can provide runway data to pilots and air traffic controllers. Runway monitoring helps reduce delays and improve runway safety. As air traffic volumes have increased, runway sensing has become an essential tool for maintaining safety standards and optimizing runway utilization.

Traditional methods of runway monitoring primarily rely on visual inspections by airport staff to detect hazards like debris or surface damage. Traditional methods also use ground-based instruments and reports from nearby weather stations to monitor weather conditions at the runway. These methods are limited by human error, weather visibility, and the time required for inspections. As a result, traditional methods of runway monitoring often can't provide real-time, comprehensive data on runway conditions.

Modern runway monitoring involves using radar, lasers, and infrared sensors to continuously monitor runway conditions in real time. However, these runway monitoring systems lack the precision required to measure, analyze, and visualize critical variables during landing and takeoff. This shortcoming can lead to safety risks, inefficient operations, and accelerated wear on aircraft components, all of which affect overall operational continuity and increase airport costs.

What is needed in the art is a runway monitoring system that can provide precise, multimodal runway and aircraft information to optimize runway use, enhance pilot performance, and reduce runway safety risks. To this end, an improved runway monitoring system is provided that is configured to provide precise runway data collection, real-time analysis, and multimodal presentation.

### SUMMARY

Novel aspects of the present disclosure are directed to a system for monitoring runways. The system comprises a plurality of sensors, a computing device, and a user interface. The sensors are configured to collect runway and aircraft data disposed about a runway. The computing device is enabled with an artificial intelligence program configured to analyze collected data and generate an output. The user interface is configured to present the output to at least one user and collect user input data.

In another aspect, the present disclosure is related to a method for monitoring a runway. The method includes collecting runway data from a plurality of sensors disposed about a runway; analyzing data using an artificial intelligence-enabled program; creating an integrated output using an artificial intelligence-enabled program; and delivering the output to a user through a user interface.

Other aspects, embodiments, and features of the present disclosure will become apparent from the following detailed description of the present disclosure when considered together with the accompanying figures. In the figures, each identical or substantially similar component that is illustrated in various figures is represented by a single numeral or notation. For the purposes of clarity, not every component is labeled in every figure. Nor is every component of each embodiment of the present disclosure shown where illustration is not necessary to allow those of ordinary skill in the art to understand the present disclosure.

### BRIEF DESCRIPTION OF THE DRAWINGS

The novel features believed characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawings, in which:

FIG. 1 illustrates a perspective view of an embodiment of a runway monitoring system designed and constructed in accordance with the disclosed principles;

FIG. 2 illustrates a block diagram of an exemplary embodiment of a runway monitoring system;

FIG. 3 illustrates a block diagram of an exemplary embodiment of a multimodal user interface for use with a runway monitoring system;

FIG. 4 illustrates a user wearing an exemplary embodiment of a user interface device for use with a runway monitoring system;

FIG. 5 illustrates an exemplary multimodal presentation delivered to a user through a user interface in accordance with the present disclosure;

FIG. 6 is a flowchart of a process for monitoring a runway using a runway monitoring device in accordance with the present disclosure;

FIG. 7 is a flowchart of a process for creating a multimodal presentation for presentation on a user interface.

INDEX OF REFERENCE NUMERALS AND DEFINITIONS

| Reference | Element |
|---|---|
| 100 | runway monitoring system |
| 102 | fiber optic sensor |
| 104 | fiber optic cable |
| 106 | computing device |
| 108 | microphone |
| 110 | gas sensor |
| 112 | camera |
| 114 | thermal sensor |
| 200 | block diagram |
| 201 | external source |
| 202 | processor |
| 203 | communication interface |
| 204 | memory |
| 206 | user interface |
| 300 | block diagram |
| 400 | user interface |
| 402 | visualization screen |
| 404 | audio output device |
| 406 | haptic device |
| 408 | controller |
| 410 | scent projector |
| 412 | camera |
| 414 | motion sensor |
| 416 | manual input device |
| 418 | microphone |
| 500 | exemplary multimodal presentation |
| 502 | visual stimuli |
| 504 | auditory stimuli |
| 506 | tactile stimuli |
| 508 | olfactory and gustatory stimuli |
| 600 | flowchart |
| 602 | step |
| 604 | step |
| 606 | step |
| 608 | step |
| 610 | step |
| 612 | step |
| 700 | flowchart |
| 702 | step |
| 704 | step |
| 706 | step |
| 708 | step |

### DETAILED DESCRIPTION

For the purpose of promoting an understanding of the principles in the present disclosure, reference will now be made to the embodiments illustrated in the drawings and specific language will be used to describe the same. It will nevertheless be understood that no limitation of the scope of the present disclosure is thereby intended. Any alterations and further modifications in the described embodiments, and any further applications of the principles of the present disclosure as described herein are contemplated as would normally occur to one of ordinary skill in the art to which the present disclosure relates. Although multiple embodiments are shown and discussed in detail, it will be apparent to those skilled in the relevant art that some features that are not relevant to the present disclosure may not be shown for the sake of clarity.

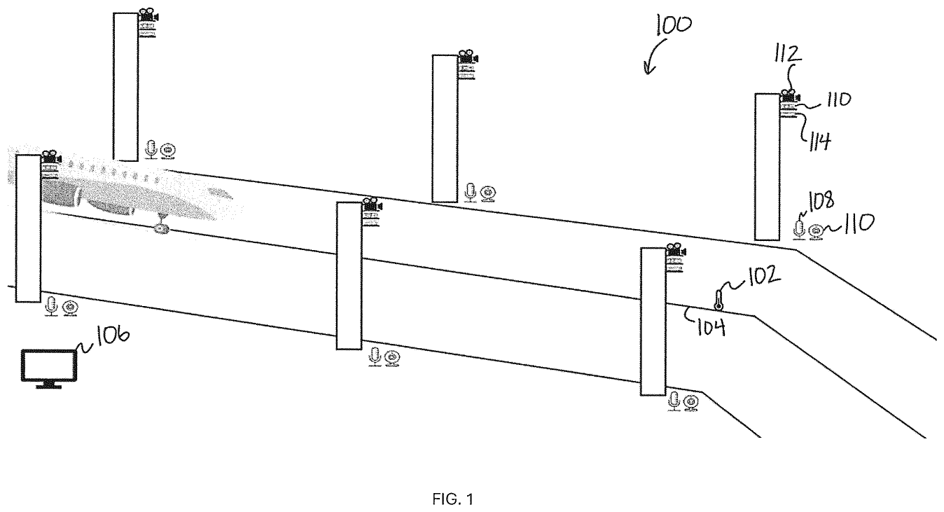

FIG. 1 illustrates a perspective view of an embodiment of a runway monitoring system 100 designed and constructed in accordance with the disclosed principles. In operation, the runway monitoring system 100 enables precise data collection, analysis, and multimodal presentation.

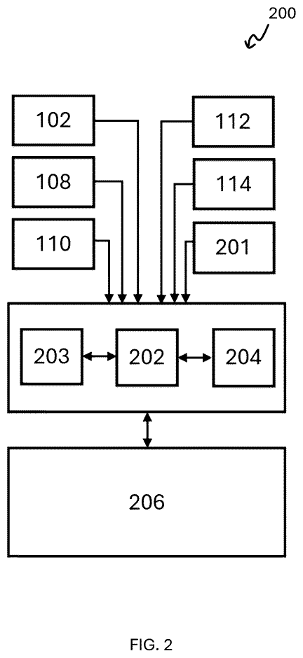

Runway monitoring system 100 may include a plurality of sensors for gathering runway and aircraft data. Sensors may be configured to detect various stimuli including but not limited to light, sound, temperature, pressure, motion, chemical composition, and force. As illustrated in FIG. 1, the runway monitoring system 100 may include a fiber optic system with one or more fiber optic sensors 102 to precisely measure noise, vibrations, and pressure changes generated by an aircraft during takeoff and landing. Data gathered by fiber optic sensors 102 may be used to detect variations in landing speed, deceleration rates, and environmental and runway conditions that affect aircraft performance. Data gathered by fiber optic sensors 102 may also be used to measure strain or deformation along the runway to measure the intensity of aircraft landing impact. This data may be used to generate quantifiable metrics regarding runway and aircraft degradation, as well as pilot performance. Data gathered by fiber optic sensors 102 may also be used for computer vision and 3D imaging, which is discussed in greater detail in FIG. 2, to monitor aircraft tire tread and runway surface degradation.

Fiber optic sensors 102 may be closely coupled to the runway for precise data collection. For example, fiber optic sensors 102 may be embedded in fiber optic cables 104 disposed along the runway. The performance of fiber optic sensors 102 is strongly influenced by their positioning relative to the stimuli being measured. It may therefore be desirable to optimize the placement of the fiber optic sensors 102 during installation to optimize data quality. Computer vision and 3D imaging, discussed in greater detail in FIG. 2 that follows, may be utilized to determine the optimal positioning of fiber optic sensors 102 during installation.

Data collected by fiber optic sensors 102 may be transmitted through one or more fiber optic cables 104 to a computing device 106. As previously discussed, fiber optic sensors 102 may be embedded in fiber optic cables 104 for distributed fiber optic sensing, distributed temperature sensing, and distributed acoustic sensing. In another embodiment, fiber optic sensors 102 may be external to the fiber optic cables 104. In the non-limiting embodiment depicted in FIG. 1, multiple fiber optic cables 104 with embedded fiber optic sensors 102 may be disposed along the runway. As shown in FIG. 1, one fiber optic cable 104 may be disposed on each edge of the runway and one fiber optic cable 104 may be disposed down the center of the runway. One of ordinary skill in the art will recognize that other configurations of fiber optic cables 104 are within the scope of the claims. For example, one fiber optic cable 104 may be disposed in a nonlinear (e.g. snaking) path along the runway such that the fiber optic cable is disposed on each edge as well as the center of the runway.

Fiber optic sensors 102 may also be disposed along taxiways that connect runways to hangars and terminals. Data gathered by fiber optic sensors 102 disposed along the taxiway may be used to track aircraft tire surface degradation and detect mechanical failures. Data gathered by fiber optic sensors 102 disposed along the taxiway may also be used to track taxiway traffic and detect foreign objects on the runway to avoid collision. Fiber optic sensor 102 data may also be used to track taxiway surface degradation.

The runway monitoring system 100 may also include a plurality of microphones 108 to precisely measure sound at the runway. Data gathered by microphones 108 may be used to detect variations in aircraft sound during takeoff and landing, aircraft tire degradation, aircraft mechanical failure, and runway surface degradation. Data gathered by microphones 108 may also be used to measure landing impact and the efficacy of aircraft noise abatement measures. Microphones 108 may be positioned and oriented to optimize data collection. For example, microphones 108 may be disposed in various locations along the edge of the runway for distributed data collection. Microphones 108 may be positioned at a predetermined distance from the edge of the runway to optimize the precision of data collection. As a non-limiting example, microphones 108 may be disposed 5-20 meters from the edge of the runway. Microphones 108 may also be positioned close to the ground to minimize wind noise that may interfere with the precise measurement of aircraft and runway noise. In the non-limiting exemplary embodiment depicted in FIG. 1, microphones 108 may be disposed on the ground on either side of the runway, and positioned at both ends of the runway as well as at the halfway point. Because the runway environment is characterized by significant ambient noise, it may be advantageous to select microphones 108 capable of directional pickup to minimize the capture of unwanted background noise. It may also be advantageous to select different types of microphones 108 for each location based on the auditory stimuli intended for capture. As a non-limiting example, microphones 108 disposed at the far end of the runway may be shotgun directional microphones configured to capture sound from a narrow, long-distance area to capture aircraft noise during approach and touchdown. Microphones 108 disposed at the halfway point and the near end of the runway may be cardioid microphones configured to capture sound from a wider frontal area to capture aircraft noise during touchdown and rollout.

The runway monitoring system 100 may further include gas sensors 110 to precisely measure atmospheric components present at the runway. Data gathered by gas sensors 110 may be used to track aircraft exhaust emissions such as CO₂ and NOx and monitor airport air quality, as well as to detect the use of low-quality fuel and measure fuel burn characteristics. Airports may use this data to monitor environmental compliance and identify potential aircraft engine inefficiencies. Gas sensors 110 may be positioned and oriented to optimize data collection. For example, gas sensors 110 may be oriented in direction of the wind during aircraft takeoff and landing to enhance gas detection and accurately monitor gas dispersion patterns. Gas sensors 110 may also be disposed in various locations along the edge of the runway for distributed data collection. Gas sensors 110 may be positioned near the ground to detect heavier gases and minimize the effect of wind and temperature variations. These gas sensors 110 may be positioned at a predetermined distance from the edge of the runway to optimize the precision of data collection. As a non-limiting example, gas sensors 110 positioned near the ground may be disposed 10-30 meters from the edge of the runway. In the non-limiting exemplary embodiment depicted in FIG. 1, gas sensors 110 may be disposed on the ground alongside microphones 108. Gas sensors 110 may also be disposed in an elevated position relative to the runway to avoid interference from ground-level pollutants, dust, or debris and ensure better airflow. In the non-limiting exemplary embodiment depicted in FIG. 1, gas sensors 110 may be mounted on poles disposed on either side of the runway and positioned at both ends of the runway as well as at the halfway point. Jet blasts from aircraft engines generate intense heat, high-speed winds, and forceful pressure waves that can cause significant damage to objects in their path. Mounting equipment or structures in the path of jet blasts could lead to structural failure, safety hazards, and potential damage to both the mounted items and surrounding areas. It may therefore be advantageous to mount sensors gas sensors 110 on poles that are sized to ensure precise data collection while avoiding the path of jet blasts. It may also be advantageous to select different gas sensors 110 for each location based on the characteristics of that location and the atmospheric components to be detected. As a non-limiting example, gas sensors 110 disposed near the ground may be electrochemical gas sensors configured to capture high concentrations of heavier gases at ground level. Gas sensors 110 mounted on poles may be optical gas sensors configured to use light absorption to capture the concentration of lighter gases over larger areas.

The runway monitoring system 100 may also include a plurality of cameras 112 to capture images of the runway. Data gathered by cameras 112 may be used to measure landing impact and consistency, descent angle, and braking efficiency, and detect weather conditions as well as runway damage and debris. This data may also be used to detect aircraft degradation and mechanical failures. Data gathered by cameras 112 may also be used for computer vision and 3D imaging, discussed in greater detail in FIG. 2, to monitor aircraft tire tread and runway surface degradation, as well as monitor aircraft orientation during critical phases of takeoff and landing. Cameras 112 may be positioned and oriented to optimize visual data collection. For example, cameras 112 may be disposed in an elevated position relative to the runway to avoid obstructions and improve the field of view. Cameras 112 may also be disposed in various locations along the edge of the runway for distributed data collection. In the non-limiting exemplary embodiment depicted in FIG. 1, cameras 112 may be mounted alongside gas sensors 110 on poles disposed on either side of the runway and positioned at both ends of the runway as well as at the halfway point. Many types of cameras are within the scope of the claims. As a non-limiting example, the cameras 112 may be high-resolution cameras capable of capturing 360-degree spherical images.

The runway monitoring system 100 may also include thermal sensors 114 to precisely measure heat at the runway. Data gathered by thermal sensors 114 may be used to detect runway damage, hotspots, or debris and measure landing impact on aircraft and the runway. Data gathered by thermal sensors 114 may also be used for computer vision, 3D imaging, and artificial intelligence fusion with data gathered from fiber optic sensors 102, discussed in more detail in FIG. 2, to monitor aircraft tire and runway degradation. Thermal sensors 114 may be positioned and oriented to optimize data collection. For example, thermal sensors 114 may be disposed in various locations along the edge of the runway for distributed data collection. Thermal sensors 114 may also be disposed in an elevated position relative to the runway to avoid obstruction and interference by other objects on or near the runway. In the non-limiting exemplary embodiment depicted in FIG. 1, thermal sensors 114 may be mounted alongside gas sensors 110 and cameras 112 on poles disposed on either side of the runway and positioned at both ends of the runway as well as at the halfway point. Many types of thermal sensors are within the scope of the claims. As a non-limiting example, the thermal sensors 114 may be long-wave infrared sensors. One of ordinary skill in the art will recognize that other configurations of sensors are within the scope of the claims.

The runway environment is often characterized by a range of hazardous conditions that can damage or interfere with sensors, thereby reducing data quality. It may therefore be advantageous to include protective enclosures (not shown) for sensors. Enclosures may be weather-resistant to shield the sensors from environmental conditions such as rain, dust, and heat. Enclosures may also prevent damage to sensors from debris and vehicles traversing the runway. Enclosures may also limit interference and the collection of unwanted data, thereby improving data quality.

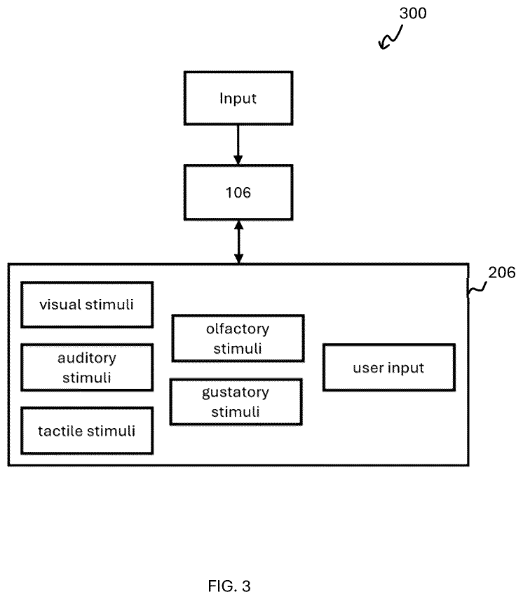

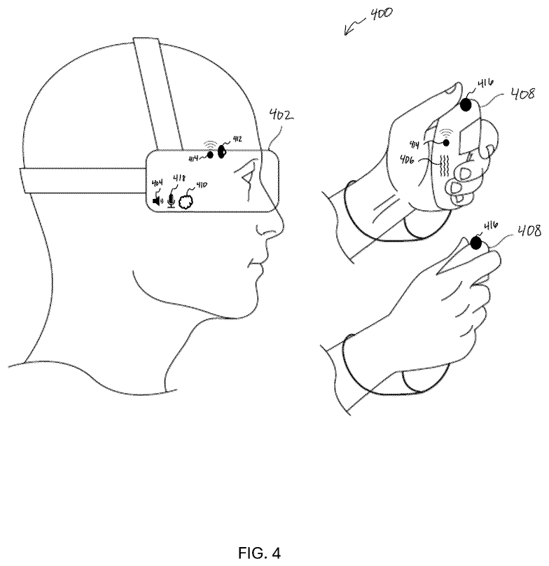

FIG. 2 illustrates a block diagram 200 of an exemplary embodiment of a runway monitoring system 100 in accordance with the disclosed principles. In this non-limiting exemplary embodiment, data from fiber optic sensors 102, microphones 108, gas sensors 110, cameras 112, and thermal sensors 114 may be transmitted to a computing device 106. Data from external sources 201 may also be transmitted to the computing device 106 to enable comprehensive analysis of sensor data. As a non-limiting example, external sources 201 may include airport weather observation stations providing data regarding weather conditions surrounding the runway. As another non-limiting example, external sources 201 may include airlines and air traffic control providing aircraft data such as flight number, aircraft type and age, and flight plan. User input data collected by the user interface 206, discussed in further detail in FIGS. 3 and 4, may also be transmitted to the computing device 106 for storage and analysis.

The computing device 106 may include one or more processing units 202 for processing input data, optimizing data, and generating output for delivery to the user. In one embodiment, the processing unit 202 may be artificial intelligence-enabled. Using a machine learning model, the processing unit 202 can perform various functions to evaluate input data utilizing anthropomorphic computing. As a non-limiting example, the processing unit 202 may perform multi-sensor fusion to provide a detailed analysis of landing precision and runway interactions. That is, the processing unit 202 may combine input data from the various sensors described herein to generate a comprehensive and dynamic representation of the environment, runway, and aircraft being monitored. Other functions of the processing unit 202 include but are not limited to identifying patterns and anomalies in aircraft performance, simulating likely landing scenarios and outcomes, and generating quantifiable metrics regarding runway degradation. The processing unit 202 may also use computer vision and 3D imaging to monitor a variety of aircraft metrics, including but not limited to aircraft landing gear and engine noise, landing gear wheel sliding, skidding, and rotational friction, and brake engagement timing and intensity. Computer vision and 3D imaging may also be used to monitor runway conditions, including but not limited to vehicle traffic adjacent to the runway, runway damage, and the presence of debris. Images generated by the processing unit 202 may also be processed with real-time object detection software to identify runway failure modes. The processing unit 202 may also analyze user input data and modify the machine learning model accordingly. The machine learning model may be tailored to the user such that the processing unit 202 may adapt to the user's individual needs, accurately predict user response, and modify outputs to reflect the user's preferences, thereby improving performance and accuracy over time. The machine learning model may include one or more reward mechanisms for tailoring functionality to the user.

The processing unit 202 may also use the artificial intelligence program to optimize data storage, processing, and delivery. As a non-limiting example, the processing unit 202 may store input data according to the metric being measured as opposed to the input source. The processing unit 202 may also ensure the processing of only high-quality data by eliminating low-quality or extraneous data. The processing unit 202 may also optimize data delivery by tuning the input data to the output modality or modalities best suited to the data range and intended use.

The processing unit 202 can also generate output for delivery to the user via the user interface 206. As a non-limiting example, the output may include a multimodal presentation that delivers aircraft and runway information to one or more human senses, discussed in greater detail in FIGS. 3-5 that follow. The output may also include customizable dashboards for the delivery of multimodal presentations to a variety of users and user interfaces 106.

The processing unit 202 may be coupled to a memory 204 which can store input data for transmission, further processing, or later retrieval. The memory 204 may also contain an artificial intelligence-enabled program for analyzing and presenting data. The memory 204 may include one or more memory components, and may include non-volatile memory, volatile memory, or some combination of the two.

The computing device 106 may also include a communications interface 203 to facilitate communication with other systems or devices. The communications interface 203 may support communications through any suitable physical or wireless communication link. For example, communications interface 203 may include a network interface card or a wired or wireless transceiver to facilitate communication over a network. The communication interface 203 can be used to facilitate communication between multiple users. For example, the communications interface 203 may provide for sanitized cockpit to tower communication. Other examples include but are not limited to airport ground control to cockpit communication, operations (i.e., jet bridge, ground crew, etc.) communication, and communication between airports. The communications interface 203 may also facilitate communication between a user and the computing device 106. For example, the communications interface may include a speech to text human machine interface, allowing users to provide input to the computing device 106 by speaking commands. The communications interface 203 may also be enabled with an artificial intelligence-enabled large language model.

The computing device 106 may also include a variety of additional features not illustrated in FIG. 2. For example, the computing device 106 may include data security measures like end-to-end encryption. The computing device 106 may also include a data management system to optimize the storage, organization, and retrieval of data. As a non-limiting example, the data management system may allow data stored in the memory 204 to be deleted, updated, and/or retrieved according to an artificial intelligence-enabled program. The computing device 106 may also include flexible application programming interfaces (APIs) to allow communication with external software systems. As a non-limiting example, the flexible APIs may allow the computing device 106 to communicate with weather station software to access runway weather data. The computing device 106 may also utilize edge computing to process data closer to the source, reducing latency and bandwidth needs, improving data security, and enabling real-time data analysis. Edge computing may also optimize productivity and allow for movement mapping. Edge computing also enables interaction between the computing device 106 and mobile and stationary equipment tags (i.e., RFID) present on the runway. Edge computing may be supported by federated machine learning for multi-system learning and learning package redistribution among a plurality of runway monitoring systems 100 without uploading private data to a central platform. As a non-limiting example, a computing device 106 may act as an independent node within a network of runway monitoring systems 100, generating local updates based on unique runway, aircraft, and environmental data. Local updates may be securely aggregated at a central server to refine the global machine learning model without transferring sensitive or personally identifiable information to the central server. The central server may aggregate the local updates from all participating runway monitoring systems 100 through a secure federated aggregation process and then send the updated machine learning models back to individual runway monitoring systems 100.

The computing device 106 may be coupled to a user interface 206 for delivery of the output generated by the processing unit 202 and collection of user input data. The user interface 206 is discussed in greater detail in FIG. 3 that follows.

FIG. 3 illustrates a block diagram 300 of an exemplary embodiment of a user interface 206 in accordance with the disclosed principles. The user interface 206 may be configured to present runway information to multiple human senses, including sight, sound, touch, smell, and taste. That is, the user interface 206 may deliver visual, auditory, tactile, olfactory, and gustatory stimuli to provide a multimodal presentation to the user. As a non-limiting example, the user interface 206 may deliver aircraft landing information by presenting a 3D rendering of the aircraft during landing (visual stimuli), chimes indicating mechanical failures (auditory stimuli), vibrations corresponding to aircraft noise levels (tactile stimuli), and scents indicating the atmospheric components at the runway (olfactory and gustatory stimuli). The user interface 206 may also direct stimuli to particular senses to enable a user to distinguish between various sources of information. As a non-limiting example, data from fiber optic sensors may be delivered through tactile stimuli while data from cameras may be delivered through visual stimuli. The delivery of a multimodal stimuli is discussed in greater detail in FIG. 4 that follows.

The user interface 206 may deliver the multimodal presentation to one or more human or non-human users. In one embodiment, a plurality of stimuli types may be presented in one integrated multimodal presentation. In another embodiment, the multimodal presentation may be partitioned such that each user is presented with a different stimulus or information type.

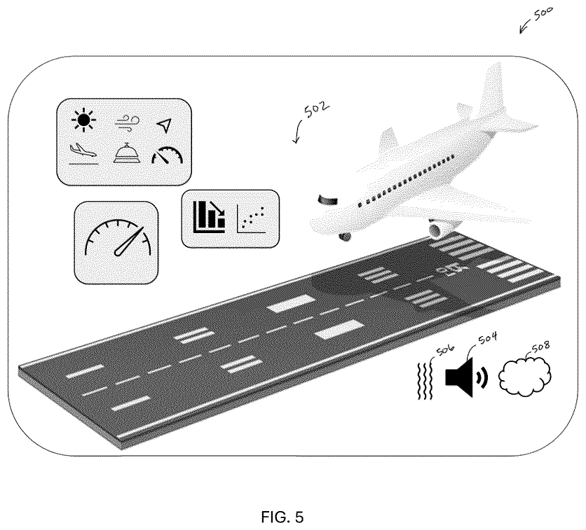

The user interface 206 may deliver the multimodal presentation in a variety of formats. In one embodiment, the user interface 206 may provide the multimodal presentation in an augmented reality environment wherein the multimodal presentation is overlaid onto the user's environment such that the user may remain aware of his surroundings. In another embodiment, the user interface 206 may provide the multimodal presentation in an immersive virtual reality environment. In yet another embodiment, the multimodal presentation may be provided on a conventional computer monitor or personal communication device. An exemplary multimodal presentation that may be delivered to a user via the user interface 206 is provided in FIG. 5.

The user interface 206 may also allow a user to interact with the multimodal presentation and collect user input data. User input data may be transmitted to the computing device 106, where it may be stored and delivered to the artificial intelligence-enabled processing unit 202 for evaluation and integration into the multimodal presentation. User input data may also be translated into actions in relation to the multimodal presentation. In a non-limiting exemplary embodiment, the user interface 206 may also collect manual user input data as well as user speech and movement data. The collection of user input data is discussed in greater detail in FIG. 4 that follows.

FIG. 4 illustrates a user with an exemplary user interface 400 in accordance with the disclosed principles. The user interface 400 may be configured to deliver a multimodal presentation to a user. The user interface 400 may include one or more visualization screens 402 to facilitate the delivery of a visual component of the multimodal presentation. The visualization screen 402 may display two-dimensional and three-dimensional visual components of the multimodal presentation. As a non-limiting example, the visualization screen 402 may display 3D reconstructions of aircraft landings. In the non-limiting embodiment illustrated in FIG. 4, the visualization screen 402 may be a wearable headset that covers the user's eyes for visual immersion. In an alternative embodiment, the visualization screen 402 may be provided by a conventional computer monitor or tablet. Other examples of visualization screens that can achieve the same utility are within the scope of the claims.

The user interface 400 may also include one or more audio output devices 404 to facilitate the delivery of an auditory component of the multimodal presentation. As a non-limiting example, the audio output devices 404 may deliver varying volumes of sound corresponding to aircraft engine sounds present at the runway. In the non-limiting embodiment depicted in FIG. 4, the audio output device 404 may be integrated into a wearable headset. In an alternative embodiment, audio output device 404 may be provided through a separate user interface 400 component. Examples include but are not limited to standalone speakers, air conduction headphones, and bone conduction headphones.

The user interface 400 may also include haptic devices 406 for the delivery of a tactile component of the multimodal presentation. As a non-limiting example, the haptic devices 406 may deliver varying vibration intensities corresponding to the intensity of aircraft landing impact. In the non-limiting embodiment illustrated in FIG. 4, the haptic devices 406 may be handheld controllers 408 with vibration motors and actuators. In another embodiment, haptic devices 406 may be haptic-enabled gloves or suits. Other examples of haptic devices that can achieve the same utility are within the scope of the claims.

The user interface 400 may also include one or more scent projectors 410 for the delivery of an olfactory component of the multimodal presentation. As a non-limiting example, the scent projector 410 may deliver the scent of rain to indicate rainfall at the runway. Olfactory stimuli provided by the scent projector 410 may also be used to deliver a gustatory component of the multimodal presentation. In the non-limiting embodiment illustrated in FIG. 4, scent projectors 410 may be integrated into a wearable headset. In another embodiment, the scent projectors 410 may be provided through a separate user interface 400 component disposed in the user's environment.

The user interface 400 may also allow a user to interact with the multimodal presentation and provide user input data. As a non-limiting example, the user interface 400 may include cameras 412 and motion sensors 414 to collect data regarding the user's movements and interactions. In the non-limiting exemplary embodiment illustrated in FIG. 4, cameras 412 and motion sensors 414 may be integrated into a wearable headset. The controllers 408 may also include motion sensors 414 to detect and track a user's movements.

The user interface 400 may also include manual input devices 416 to collect input data from the user. In the non-limiting exemplary embodiment illustrated in FIG. 4, manual input devices 416 may be buttons on the controllers 408. In an alternative embodiment, manual input devices 416 may be provided through a separate user interface 400 component. Examples include but are not limited to keyboard and mouse interfaces, trackpads, game controllers, and touch-enabled screens.

The user interface 400 may also include microphones 418 to collect the user's auditory input. In the non-limiting exemplary embodiment illustrated in FIG. 4, microphones 418 may be integrated into a wearable headset. In an alternative embodiment, microphones 418 may be standalone or integrated into another component of the user interface 400.

Many other embodiments of user interfaces 400 that can achieve the same utility are within the scope of the claims. For example, in one non-limiting exemplary embodiment, each component of the user interface 400 may be provided through a user's personal communication device.

FIG. 5 is an exemplary multimodal presentation 500 that may be delivered to a user in accordance with the disclosed principles. As previously discussed, the multimodal presentation 500 may be delivered in a variety of environments, including but not limited to an augmented reality environment, immersive virtual reality environment, or on a conventional computer monitor or personal communication device. In the non-limiting exemplary multimodal presentation 500 depicted in FIG. 5, the user may be presented with visual stimuli 502 such as landing simulations, dials, and warning symbols. The user may also be presented with auditory stimuli 504 such as chimes, aircraft engine noise, and environmental simulation and tactile stimuli 506 such as vibrations and haptics. The user may also be presented with olfactory and gustatory stimuli 508 such as scents corresponding to aircraft and runway data. As previously mentioned, the user may interact with the multimodal presentation 500 and provide input. Data corresponding to the user's inputs may be collected, stored, and evaluated to modify data collection, analysis, and delivery.

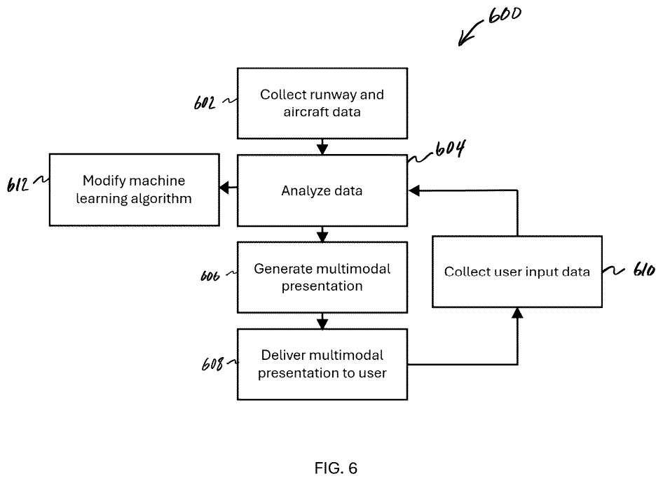

FIG. 6 is a flowchart of a process for monitoring a runway using a runway monitoring device 100 in accordance with the disclosed principles. The steps of flowchart 600 may be implemented by a runway monitoring system, such as the runway monitoring system 100 exemplified and disclosed herein. In one or more embodiments, one or more of the steps may be omitted, repeated, and/or performed in a different order. Accordingly, the specific arrangement of steps shown in FIG. 6 should not be construed as limiting the scope of the embodiments.

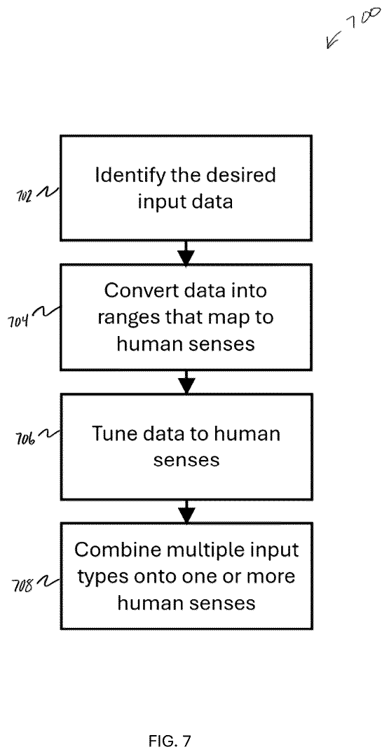

Flowchart 600 begins at step 602 by collecting runway and aircraft data. Runway and aircraft data may be collected from runway sensors as well as external sources such as weather stations, airlines, and air traffic control. In step 604, runway and aircraft data is analyzed by a computing device. The computing device may be enabled with an artificial-intelligence program for data analysis, data optimization, and output generation. As previously discussed, the computing device may utilize edge computing supported by federated machine learning to generate local updates and securely aggregate local updates at a central server without transferring sensitive information to the central server. In step 606, the computing device generates a multimodal presentation wherein input data is synthesized to create a comprehensive, integrated output. The process of generating a multimodal presentation is discussed in greater detail in FIG. 7 that follows. In step 608, the multimodal presentation is delivered to the user through a user interface. As previously discussed, the multimodal presentation may include the delivery of visual, auditory, tactile, olfactory, and gustatory stimuli and may be delivered in a variety of formats. In step 610, user input data is collected via the user interface and delivered to the processing unit for analysis. User input data may be translated into actions in relation to the multimodal presentation. In step 612, user input data may also be used to modify the machine learning algorithm, which may alter data collection, analysis, and delivery to improve performance and accuracy over time. The machine learning algorithm may also be modified by updates from a central server.

FIG. 7 is a flowchart of a process for generating a multimodal presentation for presentation through the user interface 206. The steps of flowchart 700 may be implemented by a computing device, such as the computing device 106 exemplified and disclosed herein. In one or more embodiments, one or more of the steps may be omitted, repeated, and/or performed in a different order. Accordingly, the specific arrangement of steps shown in FIG. 7 should not be construed as limiting the scope of the embodiments.

Flowchart 700 begins at step 702 by identifying the desired input data. As previously discussed, a large variety of data is collected from sensors, external sources, and user input. In step 702, the computing device sorts and filters input data to isolate relevant data from background data. In step 704, data is converted into ranges that map to human senses. As previously discussed, the multimodal presentation may include the delivery of visual, auditory, tactile, olfactory, and gustatory stimuli. Accordingly, data must be converted into stimuli that can be interpreted by various human senses such as sight and touch. In step 706, the input data is tuned to certain human senses. That is, input data may be adjusted to the output modality or modalities best suited to the data range and intended use. In step 708, multiple input types are combined onto one or more senses. Step 708 provides for the integration of all collected runway and aircraft data, as well as user inputs, to create a comprehensive, multimodal presentation for delivery to the user.

While this disclosure has been particularly shown and described with reference to preferred embodiments, it will be understood by those skilled in the pertinent field of art that various changes in form and detail may be made therein without departing from the spirit and scope of the present disclosure. The inventors expect skilled artisans to employ such variations as appropriate, and the inventors intend the present disclosure to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the present disclosure set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

We claim:

1. A system for monitoring runways, comprising:
a plurality of sensors configured to collect environmental, runway, and aircraft input data disposed about a runway,
an artificial intelligence-enabled computing device configured to analyze input data and generate an output through anthropomorphic computing; and
a user interface configured to present the output to at least one user.

2. The system of claim 1, wherein the sensors are configured to detect one or more of light, sound, temperature, pressure, motion, chemical composition, and force.

3. The system of claim 1, wherein the sensors are positioned and oriented to optimize distributed data collection.

4. The system of claim 1, wherein the sensors comprise one or more of fiber optic sensors, cameras, microphones, thermal sensors, and gas sensors.

5. The system of claim 1, wherein input data further comprises data from external sources.

6. The system of claim 1, wherein the computing device is further configured to use computer vision, 3D imaging, and multi-sensor fusion to monitor environmental, runway, and aircraft conditions.

7. The system of claim 1, wherein the computing device comprises:
a memory storing input data and artificial intelligence programming,
a processing unit communicatively coupled to the memory and a communications interface, and wherein:
the processing unit is configured to process input data, optimize data storage, processing, and delivery, and generate an output using the artificial intelligence programming, and
the communications interface is configured to facilitate communication with other systems or devices.

8. The system of claim 1, wherein the computing device utilizes edge computing.

9. The system of claim 8, wherein edge computing is supported with federated machine learning.

10. The system of claim 1, wherein the computing device optimizes data delivery by tuning input data to the output modality or modalities best suited to the data range and intended use.

11. The system of claim 1, wherein the output is a multimodal presentation including visual, auditory, tactile, olfactory, and gustatory stimuli.

12. The system of claim 11, wherein the multimodal presentation is delivered through one of an augmented reality environment, a virtual reality environment, or conventional monitor, tablet, or personal communication device.

13. The system of claim 1, wherein the user interface is configured to deliver visual, auditory, tactile, olfactory and gustatory stimuli.

14. The system of claim 1, wherein the user interface is further configured to collect user input data.

15. The system of claim 14, wherein the computing device is further configured to:
analyze user input data;
modify artificial intelligence computing algorithms according to user input data;
alter input data collection based on user input data;
generate a predictive model for predicting user responses; and
generate tailored outputs to reflect user preferences.

16. The system of claim 1, wherein the user interface is a virtual reality appliance having one or more of a visualization screen, audio output, scent projectors, camera, microphones, motion sensors, and haptics.

17. A method for monitoring aircraft and runways, comprising:
collecting environmental, aircraft, and runway data from a plurality of sensors disposed about a runway and external sources;
analyzing data using an artificial intelligence-enabled program;
generating an integrated output using an artificial intelligence-enabled program;
delivering the output to a user through a user interface; and
collecting user input data through the user interface.

18. The method of claim 17, wherein generating an integrated output comprises:
identifying the desired input data;
converting data into ranges that map to human senses;
tuning input data to particular human senses; and
combining multiple input types onto one or more senses to create a comprehensive, multimodal presentation for delivery to the user.

19. The method of claim 17, wherein the integrated output is a multimodal presentation including visual, auditory, tactile, olfactory, and gustatory stimuli.

20. The method of claim 17, further comprising transmitting user input data to the artificial intelligence-enabled program for evaluation and integration into the multimodal presentation.
